(19) United States
(12) Patent Application Publication
(10) Pub. No.: US 2012/0096990 A1
(43) Pub. Date: Apr. 26, 2012

(54) SEMI-AUTOMATED SHINGLE REMOVAL APPARATUS

(76) Inventor: Eric B. CLIFFORD, Wolfeboro, NH (US)

(21) Appl. No.: 12/910,305

(22) Filed: Oct. 22, 2010

(51) Int. Cl. E04D 15/02; B23P 17/00

(52) U.S. Cl. 81/45; 29/426.5

(57) ABSTRACT

A shingle removal apparatus comprising a handle having opposed first and second ends, a handle grip located at the first end of the handle, a base located at the second end of the handle, and a pivotable shingle removal blade pivotally attached to the base. At least one actuating mechanism couples the pivotable shingle removal blade to the base to facilitate pivoting the pivotable shingle removal blade from a horizontal normal first posit

### FIELD OF THE INVENTION

The present invention relates to an apparatus which facilitates semi-automated removal of shingles from a roof by an operator.

### BACKGROUND OF THE INVENTION

In the prior art, a variety of tools and/or other devices are well know which assist with removal of shingles from a roof. However, most of those tools and/or other devices are generally completely manually operated and thus are tedious to use and very labor intensive.

### SUMMARY OF THE INVENTION

Wherefore, it is an object of the present invention to overcome the above mentioned shortcomings and drawbacks associated with the prior art.

Another object of the present invention is to provide a shingle removal apparatus which operates in a semiautomatic manner and is relatively easy to operate so as to increase the rate at which shingles are removed from a roof.

A further object of the present invention is to provide a shingle removal apparatus which is powered by compressed air which is a power source commonly used by roofers for powering other associated equipment, such as a pneumatic air hammer, when applying shingles to a roof.

Yet another object of the present invention is to provide a shingle removal apparatus which is relatively inexpensive to manufacture and operate but is reliable and durable in order to permit continuous operation of the shingle removal apparatus for a prolonged period of time and under extreme operating conditions.

A further object of the present invention is to provide a shingle removal apparatus with an accumulation chamber, typically formed within an interior of the handle, which permits a sufficiently large quantity of pressurized fluid to be stored closer to the actuator of the shingle removal apparatus so that the actuator may be cycled at a faster rate and thereby increase the speed at which the shingle removal apparatus can be operated.

A still further object of the present invention is to provide a shingle removal apparatus with a safety mechanism which facilitates attaching a safety line for securing the shingle removal apparatus to either a belt worn by an operator or to some other area of the roof so as to prevent the shingle removal apparatus from inadvertently falling, rolling and/or being pushed off the roof.

The present invention also relates to a shingle removal apparatus comprising: a handle having opposed first and second ends; a handle grip located at the first end of the handle; a base located at the second end of the handle; a pivotable shingle removal blade being pivotally attached to the base; and at least one actuating mechanism coupling the pivotable shingle removal blade to the base, to facilitate pivoting the pivotable shingle removal blade from a horizontal normal first position into an inclined second position, which assists with removing shingles from a roof.

The present invention also relates to a method of removing shingles with a shingle removal apparatus comprising a handle having opposed first and second ends, a handle grip located at the first end of the handle, a base located at the second end of the handle, a pivotable shingle removal blade being pivotally attached to the base; and at least one actuating mechanism coupling the pivotable shingle removal blade to the base, to facilitate pivoting the pivotable shingle removal blade from a horizontal normal first position into an inclined second position, which assists with removing shingles from a roof, the method comprising the steps of: initiating a command from an operator of the shingle removal apparatus to the at least one actuating mechanism; pivoting, via the at least one actuator mechanism, the pivotable shingle removal blade from the first position into the second position via in response to the command initiated by an operator; and exerting a prying force, via the pivotable shingle removal blade, on shingles overlying the pivotable shingle removal blade as the pivotable shingle removal blade is pivoted from the first position into the second position to remove fasteners securing shingles to the roof, and thereby separate the shingles from the roof.

### BRIEF DESCRIPTION OF DRAWINGS

The invention will now be described, by way of example, with reference to the accompanying drawings in which:

FIG. 1 is a diagrammatic side elevation view of the automated shingle removal apparatus according to the present invention, shown in its stable first position;

FIG. 2 is a diagrammatic side elevation view of the automated shingle removal apparatus according to the present invention, shown in its second pivoted position;

FIG. 3 is a diagrammatic view showing a second embodiment of the automated shingle removal apparatus according to the present invention, shown in its stable first position;

FIG. 4 is a perspective view of the pivotable shingle removal blade according to the present invention;

FIG. 5. is a diagrammatic exploded top plan view of the teeth of the pivotable shingle removal blade according to the present invention;

FIGS. 6 and 7 show variation of the leading edge of the pivotable shingle removal blade according to the present invention;

FIG. 8 is a diagrammatic pneumatic circuit diagram of a two position, four way pneumatic valve according to the present invention;

FIG. 9 is a diagrammatic pneumatic circuit diagram of a two position, three way pneumatic valve according to the present invention;

FIG. 10 is a diagrammatic exploded of view of the hinge region of the automated shingle removal apparatus according to the present invention.

### DETAILED DESCRIPTION OF DRAWINGS

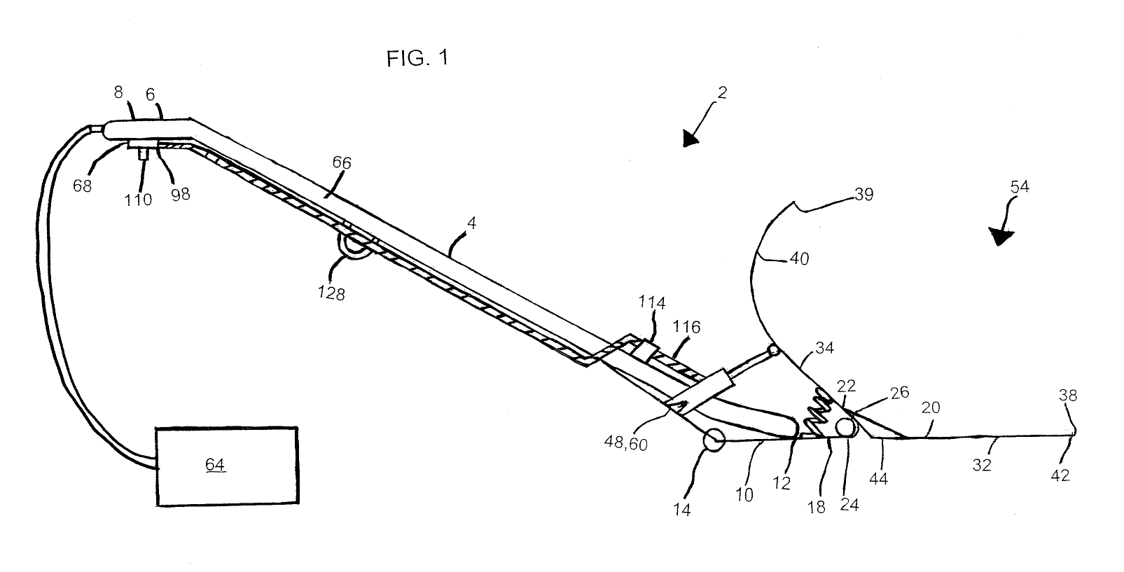

Turning now FIGS. 1-3 of the drawings, a detailed description concerning the automated shingle removal apparatus 2, according to the present invention, will now be provided. As can be seen in those figures, the automated shingle removal apparatus 2 generally comprises of an elongate handle 4 which facilitates movement and manipulation of the shingle removal apparatus 2 by an operator. A hand grip 6, or some other control or manipulation feature, is located adjacent a first end 8 of the handle 4 while a base 10, e.g., a base plate, is fixedly connected to and adjacent a second end 12 of the handle 4. A rolling member 14, e.g., a pair of rotatable wheels, a single roller, a pair of rollers, a low friction surface, etc., is supported by the base 10, or possibly by the handle 4, to facilitate movement and/or other manipulation of the base 10 as well as the shingle removal apparatus 2 and a further description concerning the purpose and function of these components will become apparent from the following. A pair of rotatable wheels or rollers is preferred form of the rolling member 14 as they assist with sharp turning, spinning or rotation of the shingle removal apparatus during use.

The base 10 typically has a length of between about 1 inch to about 15 inches, preferably about 10 inches, and a width of between about 3 inches and about 18 inches, preferably about 9.5 inches. The rolling member 14 generally spaces a bottom surface of the base 10 of the shingle removal apparatus 2 a desired distance, e.g., between about ⅛ of an inch to about 1 inch or so more preferably about ¾ of an inch or so, from a work surface such as a roof 16. Such spacing facilitates manipulation of the shingle removal apparatus 2 by an operator.

A leading portion 18 of the base 10 supports, via a horizontal hinge 22, a pivotable shingle removal blade 20. That is, a first hinge section 24 of the horizontal hinge 22 is fixedly supported, e.g., by bolts, screws or welding for example, by the leading portion 18 of the base 10 while a second hinge section 26 of the horizontal hinge 22 is fixedly supported, e.g., by bolts, screws or welding for example, by a trailing, rear surface 28 of the pivotable shingle removal blade 20. A conventional rod 30 is located between and couples the first and second hinge sections 24, 26 with one another and defines the hinge axis. The rod 30 facilitates pivoting movement of the horizontal hinge 22 and thus pivoting movement of the pivotable shingle removal blade 20 relative to the base 10, and a further description concerning the purpose and function of the same will follow. The base 10 preferably spaces the horizontal hinge 22 sufficiently away from the rolling member 14 so that when the shingle removal blade 20 is actuated, as described below, the prying force of the shingle removal blade 20 is absorbed by the leading end of the base 10 and transfer primarily to the roof instead of to the rolling member 14 and possibly causing damage thereto.

The pivotable shingle removal blade 20 generally comprises a relatively thin and flat but relatively strong and durable plate section 32. A leading edge 38 of the plate section 32 is generally slightly tapered to assist with penetration of the leading edge 38 of the pivotable shingle removal blade 20 between overlapped shingles. Preferably, the leading end 38 of the plate section 32 will be contoured or shaped so as to assist with inserting or sliding the plate section 32 between partially overlapped shingles 36 so as to facilitate removal of the top most shingles from the lower shingles by the shingle removal apparatus 2 as will be discussed below.

A first inclined section 34 is connected to a trailing end of the plate section 32. The first inclined section 34 is shaped and/or contoured so as to assist with further peeling, rolling or otherwise separating the partially or fully removed top most shingles 36 from the roof 16 and thereby assist with efficient operation of the shingle removal apparatus 2.

As shown in FIGS. 1-3, the first inclined section 34 forms an angle θ with the plate section 32 which ranges from between about 100 to about 170 degrees, more preferably ranges from between about 120 degrees and about 160 degrees and most preferably is about 140 degrees. Such an angle, formed between the first inclined section 34 and the plate section 32, facilitates and assists with further lifting, separation and removal of the leading edge of shingles 36 from the roof 16, as discussed below. A trailing edge 39 of the inclined section 34 is normally provided with a contoured or curved section 40 which further assists with rolling and folding of the removed shingles 36 back toward the leading edge 42 of the pivotable shingle removal blade 20. It is to be appreciated that the radius of curvature can vary from application to application but is generally designed to fold the removed shingles 36 back toward the leading edge 42 of the pivotable shingle removal blade 20.

A transition section 44 covers the joint formed between the plate section 32 and the first inclined section 34 so as to smooth out the interface between those two surfaces and avoid any corners or other sharp angle areas where any removed shingle 36 may catch or abut against and thereby hinder operation of the shingle removal apparatus 2. In addition, the transition section 44 typically increases the overall structural integrity of the shingle removal blade 20 and also assists with rolling and folding of the removed shingles 36 toward the leading edge 42 of the pivotable shingle removal blade 20.

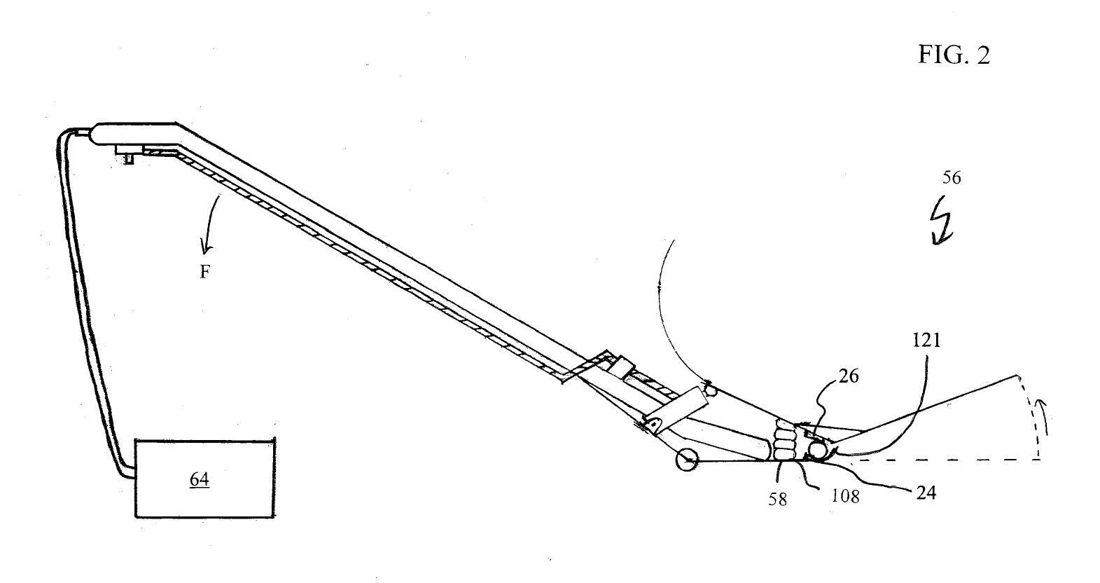

In order to control desired pivoting movement of the pivotable shingle removal blade 20 relative to the base 10, at least one actuating mechanism, such as an actuator 48 interconnects the base 10 with the pivotable shingle removal blade 20. As shown in FIGS. 1 and 2, a leading first end of the at least one actuator 48 is connected to a rear surface 50 of the first inclined section 34 of the pivotable shingle removal blade 20 while a trailing second opposite end of the at least one actuator 48 is connected to a top surface 52 of the base 10, or possibly to a lower portion of the handle 4. The actuator 48, when actuated in response to a command initiated by the operator of the device as will be discussed below, pivots or cycles the pivotable shingle removal blade 20 from its normal horizontal first position 54 (as shown in FIG. 1) into is actuated inclined second position 56 (as shown in FIG. 2), and then returns the pivotable shingle removal blade 20 back to its normal first position 54 (as shown in FIG. 1) in order to complete the shingle removal cycle and facilitate removal of desired shingles 36. As the pivotable shingle removal blade 20 is actuated into the inclined second position 56 (as shown in FIG. 2), the pivotable shingle removal blade 20 exerts a quick and powerful prying force, generally normal to the roof 16, on any shingles located on top of the pivotable shingle removal blade 20, and such force is designed to extract, pull, pry and/or remove roofing nails, staples, tacks and/or other shingles securing fasteners from the roof 16 and thereby separate and free such shingles from the roof 16. The above described shingle removal cycle will be repeatedly performed, by the operator, after any desired additional forward movement or other manipulation of the shingle removal apparatus 2, as desired sections of shingles 36 are sequentially removed from the roof 16. Preferably the attachment of the actuator 48 to the first inclined section 24 of the pivotable shingle removal blade 20 does not, in any way, hinder the peeling, rolling or otherwise separation of the engaged shingles 36 from the roof 16. It is to be appreciated that an operator may, if desired, exert a downward force in the direction of arrow F of FIG. 1, on the handle 4, when the shingle removal blade 20 is actuated, in order to increase the prying force being exerted on the shingles.

It is to be appreciated the actuator 48 may be, for example, one of a pneumatic actuator, a hydraulic actuator, an electric motor, a battery powered motor, a gas powered motor, etc. The important aspect of the actuator 48 is that it must at least be capable of exerting a sufficient biasing or prying force on the pivotable shingle removal blade 20 so as to pivot the shingle removal blade 20 from its normal biased first position 54 into its actuated second position 56. It is to be appreciated that return of the pivotable shingle removal blade 20, back to its normal biased first position 54 from the actuated second position 56, can either be accomplished by the return stroke of the actuator 48 or by an energy storage element 58, e.g., such as a compression spring, located between the base 10 and the shingle removal blade 20.

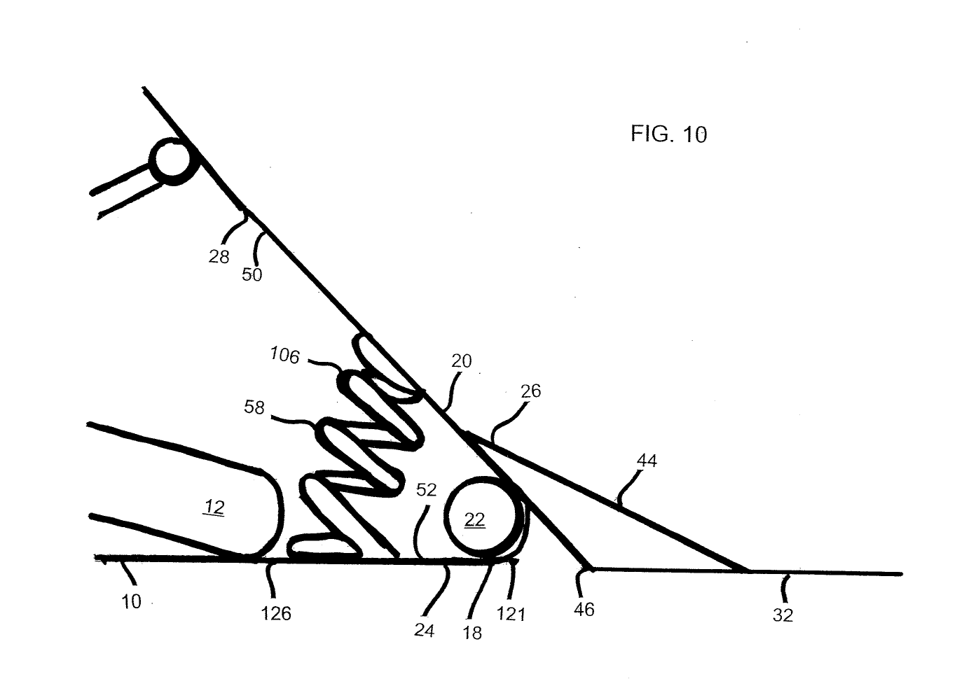

As shown in FIGS. 1 and 2, a mechanical energy storage element 58, e.g., a compression spring as shown in FIG. 10, is located between the front/top surface 52 of the base 10 and a rear surface 28 of the pivotable shingle removal blade 20 and normally adjacent the actuator 48. As actuator 48 pivots the pivotable shingle removal blade 20 from its normal biased first position 54 into its actuated second position 56, the mechanical energy storage element 58 is compressed and, once the force provided by the actuator 48 is terminated, the compressed and stored energy of the mechanical energy storage element 58 is sufficient to automatically bias or otherwise return the pivotable shingle removal blade 20 back into its normally biased first position 54 as shown in FIG. 1.

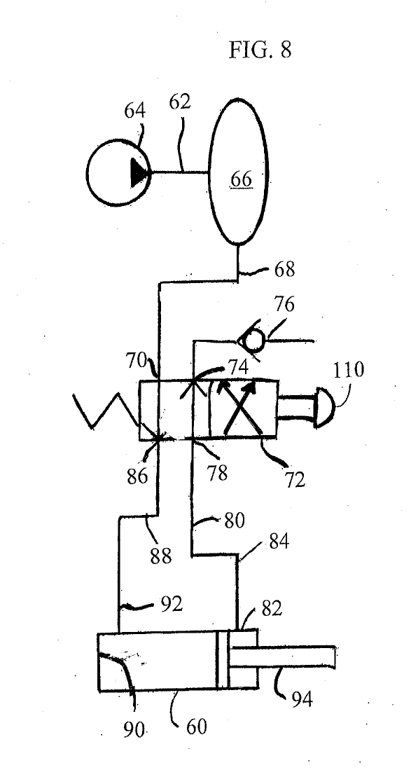

According to one embodiment of the invention as shown in FIG. 8, the actuator 48 comprises at least one pneumatic cylinder 60, or possibly two or more spaced apart pneumatically operated cylinders 60, which both have an end thereof pivotally connected with the base 10 or possibly the second end of the handle 4. In either event, pressurized air is supplied from a pressured air source 64, along a flexible conduit 62, to an accumulation chamber 66, typically formed within the interior of the handle 4 of the shingle removal apparatus 2, or possibly attached thereto. The accumulation chamber 66 permits a large quantity of pressurized air to be stored closer to the actuator 48 so that the actuator 48 may be cycled at a faster rate. The pressurized air then flows, via an air supply conduit 68, from the accumulation chamber 66 through a first inlet 70 of a two position four way (“2/4”) pneumatic valve 72. A second inlet 74 of the pneumatic valve 72 is coupled to an exhaust vent or valve 76, e.g., such as a one-way valve, which permits the pressurized air to be vented into the surrounding environment. The pneumatic valve 72 receives pressurized air from the accumulation chamber 66 via the first inlet 70 of the pneumatic valve 72 and can divert the pressurized air along one of two possible flow paths. A first outlet 78 of the 2/4 pneumatic valve 72 is coupled, via a first supply conduit 80, to supply the pressurized air to a first end 82 of each pneumatic cylinder 60 and thereby form a first flow path 84. A second outlet 86 of the pneumatic valve 72 is coupled, via a second supply conduit 88, to supply the pressurized air to an opposite second end 90 of each pneumatic cylinder 60 and thereby form a second flow path 92. In this embodiment, the pressurized air normally flows along the second flow path 92 so as to bias the actuator 48 and, in turn, the shingle removal blade 20 into its normal horizontal first position 54 (as shown in FIG. 1).

As a result of this arrangement, when the pneumatic valve 72 is actuated by the operator depressing the button 110 so that pressurized air flows from the accumulation chamber 66 along the first flow path 84 to the first end 82 of each pneumatic cylinder 60, an internal piston 94, located within each pneumatic cylinder 60, is forced toward the opposite, second end 90 of the pneumatic cylinder 60. Since the opposite end of each piston 94 is pivotally connected, in a conventional manner, with the first inclined section 34, this motion, in turn, forces the first inclined section 34 of the pivotable shingle removal blade 20 to be pulled or otherwise biased, about the horizontal hinge 22, toward the base 10 and into the actuated second position 56 (see FIG. 2). As long as pressurized air continues to be supplied along the first flow path 84 to the first end 82 of each pneumatic cylinder 60, each internal piston 94 will remain located adjacent the opposite, second end 90 of the pneumatic cylinder 60 and retain the pivotable shingle removal blade 20 is its actuated second position 56 as shown in FIG. 2.

When the pneumatic valve 72 is actuated so that pressurized air then flows from the accumulation chamber 66 along the second flow path 92 to the second end 90 of each pneumatic cylinder 60, e.g., the operator releases the button 110 so that a spring biases the button 110 back into is normal position, each internal piston 94, located within each pneumatic cylinder 60, is forced toward the opposite first end 82 of each pneumatic cylinder 60 and such supplied air pressure, in turn, forces the first inclined section 34 of the pivotable shingle removal blade 20 to be biased away from the base 10 and back into the normal first position 54 (as shown in FIG. 1) to complete the shingle removal cycle. As long as pressurized air continues to be supplied along the second flow path 92 to the second end 90 of each pneumatic cylinder 60, each internal piston 94 will remain located adjacent the first end 82 of each pneumatic cylinder 60 and the pivotable shingle removal blade 20 will remain in its normal first position 54. The above described shingle removal cycle, i.e., for FIG. 1 to FIG. 2 and then back to FIG. 1, will be repeatedly performed by an operator as desired sections of shingles 36 are removed from the roof 16.

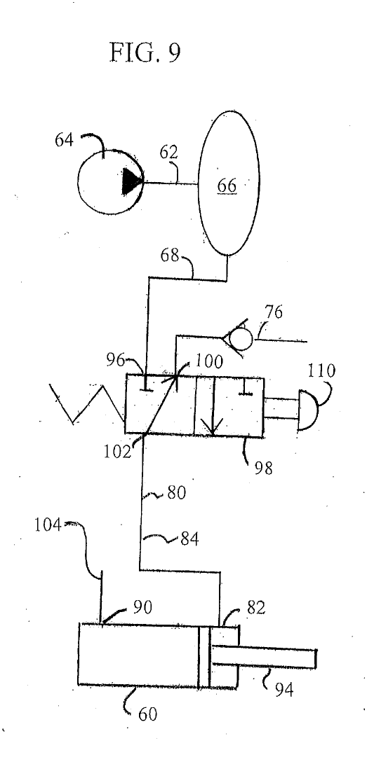

According to another embodiment of the invention, as shown in FIG. 9, the actuator 48 comprises at least one pneumatic cylinder 60, or possibly two or more spaced apart pneumatically operated cylinders 60. In either event, pressurized air is supplied from a pressured air source 64, along the flexible conduit 62, to the accumulation chamber 66, typically formed within the interior of the handle 4 of the shingle removal apparatus 2, or possibly attached thereto. The pressurized air then flows from the accumulation chamber 66, via an air supply conduit 68, to a first inlet 96 of a two position three way (“2/3”) pneumatic valve 98. The pneumatic valve 98 includes a button 110 which is spring biased into a normal first position which prevents flow of any pressurized air to the actuator 48.

A first outlet 102 of the pneumatic valve 98 is coupled, via a first supply conduit 80, to a first end 82 of each pneumatic cylinder 60 to form a flow path 84 which supplies the pressurized air to the first end 82 of each actuator 48. An opposite, second end 90 of each pneumatic cylinder 60 is coupled to an exhaust outlet 104 which facilitates venting, to the surrounding environment, of any air contained within the second end of the cylinder 60 when the piston 94 is biased from the first end toward the second end of the cylinder 60. A second inlet 100 of the pneumatic valve 98 is coupled to an exhaust vent or valve 76, e.g., such as a one-way valve, which vents the pressurized air from the flow path 84 into the surrounding environment.

As a result of this arrangement, when the pneumatic valve 98 is actuated by the operator depressing the button 110 so that pressurized air flows from the accumulation chamber 66 to the first end 82 of each pneumatic cylinder 60, the internal piston 94, located within each pneumatic cylinder 60, is forced toward the opposite, second end 90 of each pneumatic cylinder 60, and air is forced out of the second end 90 of each pneumatic cylinder 60 through the exhaust outlet 104. As each internal piston 94 is forced toward the second end 90 of each pneumatic cylinder 60, such motion, in turn, forces the first inclined section 34 of the pivotable shingle removal blade 20, which is pivotal connected with the piston 94 in a conventional manner, to be pivoted about the horizontal hinge 22 and biased toward the base 10 and into the pivoted second position 56 (as shown in FIG. 2). This, in turn, causes the compression spring or some other mechanical energy storage element 58 to be compressed from a relaxed state into a stored energy state.

As long as pressurized air continues to be supplied along the flow path 84 to the first end 82 of each pneumatic cylinder 60, each internal piston 94 will remain located adjacent the opposite, second end 90 of each pneumatic cylinder 60 and retain the pivotable shingle removal blade 20 in its elevated position. Once the flow of pressurized air along the flow path 84 is terminated, e.g., the operator releases the button 110 so that the button 110 automatically returns back into its normal first position, the pressurized air contained within the first end of the cylinder 60 can be exhausted along the flow path 84 and discharged out through the second outlet 100 of the pneumatic valve 98 via the exhaust vent or valve 76 so as not hinder the return motion (e.g., back to FIG. 1) being exerted on the pivotable shingle removal blade 20 by the mechanical energy storage element 58.

It is to be noted that while FIGS. 1 and 2 depict a compression spring for basing the pivotable shingle removal blade 20 away from the base 10 about the horizontal hinge 22, it is to be appreciated that a variety of other of mechanical energy storage elements 58 may be utilized. These include, for example, one or more hydraulic or pneumatic springs, or one or more torsion springs, including torsion coil springs, inside or proximate to the horizontal hinge 22.

When the pneumatic valve 98 is actuated so that pressurized air ceases to flow from the accumulation chamber 66 to the first flow path 84, the mechanical energy stored in the spring or other mechanical energy storage element 58 is released. This released energy forces the first inclined section 34 of the pivotable shingle removal blade 20 to be biased away from the base 10, about the horizontal hinge 22, back toward and into the normal first position 54 (as shown in FIG. 1). Such pivoting movement, in turn, returns each internal piston 94 toward the first end 82 of each pneumatic cylinder 60, forcing air through the flow path 84 and out the exhaust vent or valve 76, thus completing the shingle removal cycle. As long as the pneumatic valve 98 is in its normally biased first position as shown in FIG. 9, the pressurized air is prevented from flowing from the accumulation chamber 66 along the flow path 84, and each internal piston 94 remains located adjacent the first end 82 of each respective pneumatic cylinder 60.

It is to be appreciated that the pneumatic valve 72, 98 may be directly connected to the pressured air source 64 through the first inlet 70, but the use of the accumulation chamber 66 generally allows the shingle removal apparatus 2 to “recover” faster and operate at more cycles per minute.

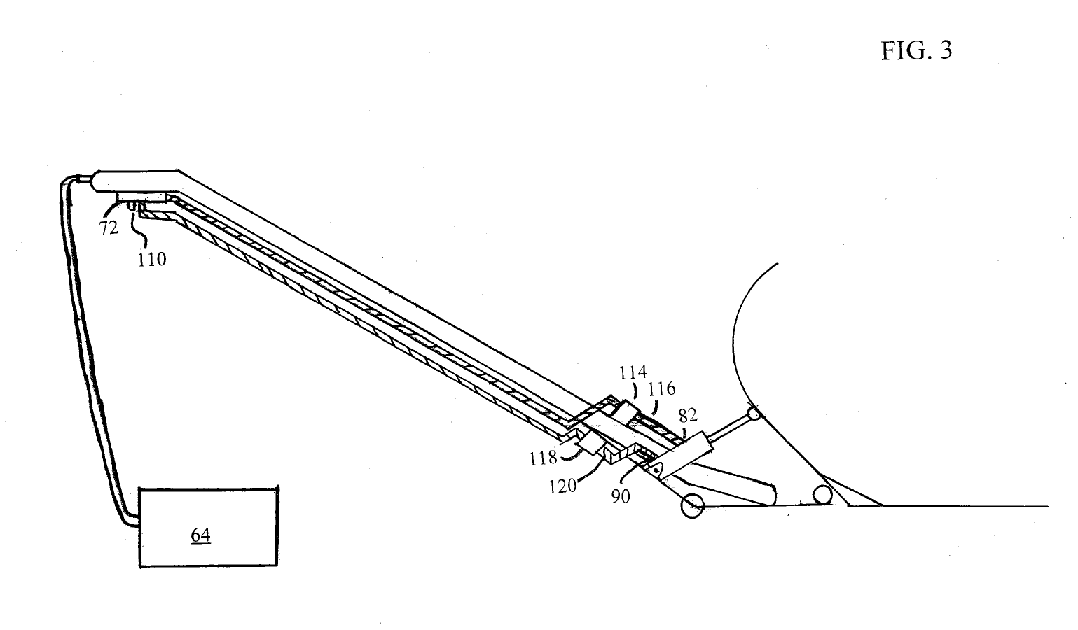

For any embodiment utilizing two or more of pneumatic cylinders 60 as the actuator 48, the pressurized air flow from the first supply conduit 80 will be divided by a first dividing element 114 into a separate first supply conduit 116 for each of the pneumatic cylinders 60. Each first supply conduit 116 will then couple with the first end 82 of each respective pneumatic cylinder 60. It is noted that the first dividing element 114 may be coupled directly to the pneumatic valve 72, 98, or may be, as shown in FIG. 1, located away from the pneumatic valve 72, 98, further down the first supply conduit 80, and may be in the form of a fluid flow divider or a simple pipe juncture. As shown in FIG. 3, in embodiments utilizing two or more pneumatic cylinders 60, where the pneumatic cylinders 60 are actuated in both directions by pressurized air, an additional second dividing element 118 and second supply conduits 120 will be arranged in a similar manner. Each second distal supply conduit 120 will extend from the second dividing element 118 and be coupled with the second end 90 of each respective pneumatic cylinder 60.

As shown in FIG. 10, because the shingle removal apparatus 2 may be used in extreme conditions, e.g., on a hot roof during hot summer months where removed shingles, loose tar, nails, tar paper, debris, etc., are present and can easily clog or hinder pivoting movement of the horizontal hinge 22, a bottom facing surface of the horizontal hinge 22 is preferably shielded by a shield 121 or otherwise protected so as to minimize the possibility of any removed shingles, loose tar, nails, tar paper, debris, etc., becoming lodged and/or entrapped within in the horizontal hinge 22 and thereby preventing or otherwise hindering the desired pivoting motion thereof during use of the shingle removal apparatus 2.

To provide additional structural integrity to the plate section 32 of the pivotable shingle removal blade 20 and minimize flexing or bending thereof during use, one or more smooth impressions, depressions, deformations, groves, indentations or other surface contours 122 are formed in the surface of the plate section 32. The formation of such smooth impressions, depressions, deformations, groves, indentations or other surface contours 122, within the surface 124 of the plate section 32 of the pivotable shingle removal blade 20, increase the overall rigidity of the plate section 32 and thereby improve its durability as well as minimizing deflection and/or flexing of the plate section 32 as the plate section 32 is pivoted into its actuated second position to remove nails, staples, tacks, other securing fasteners, tar paper, shingles, etc., from the roof 16.

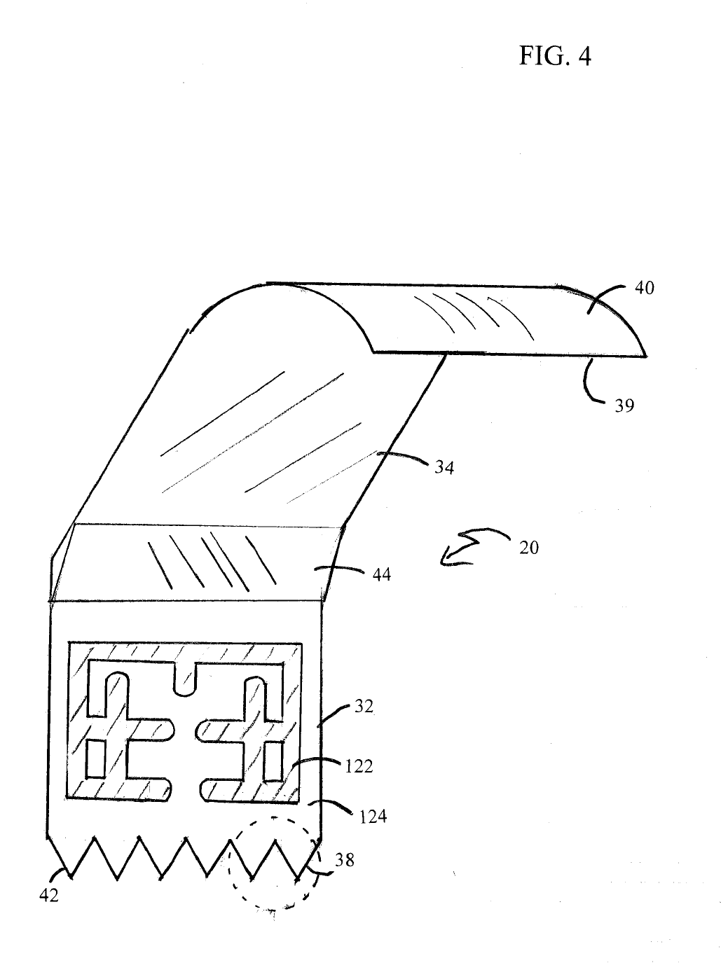

In addition, as shown in FIG. 4, the leading end 38 of plate section 32 of the pivotable shingle removal blade 20 has a generally saw tooth profile with a desired array of smooth impressions, depressions, deformations, groves, indentations or other surface contours 122 formed into the surface of a remainder of the plate section 32 of the pivotable shingle removal blade 20. It is to be appreciated that the smooth impressions, depressions, deformations, groves, indentations or other surface contours 122 formed in the surface of the plate section 32 can have a variety of different configurations which are each designed to increase the overall structural integrity of the plate section 32 so that the plate section 32 resists flexing and deformation when removing nails, tacks, staples, securing fasteners and shingles 36 from a roof 16.

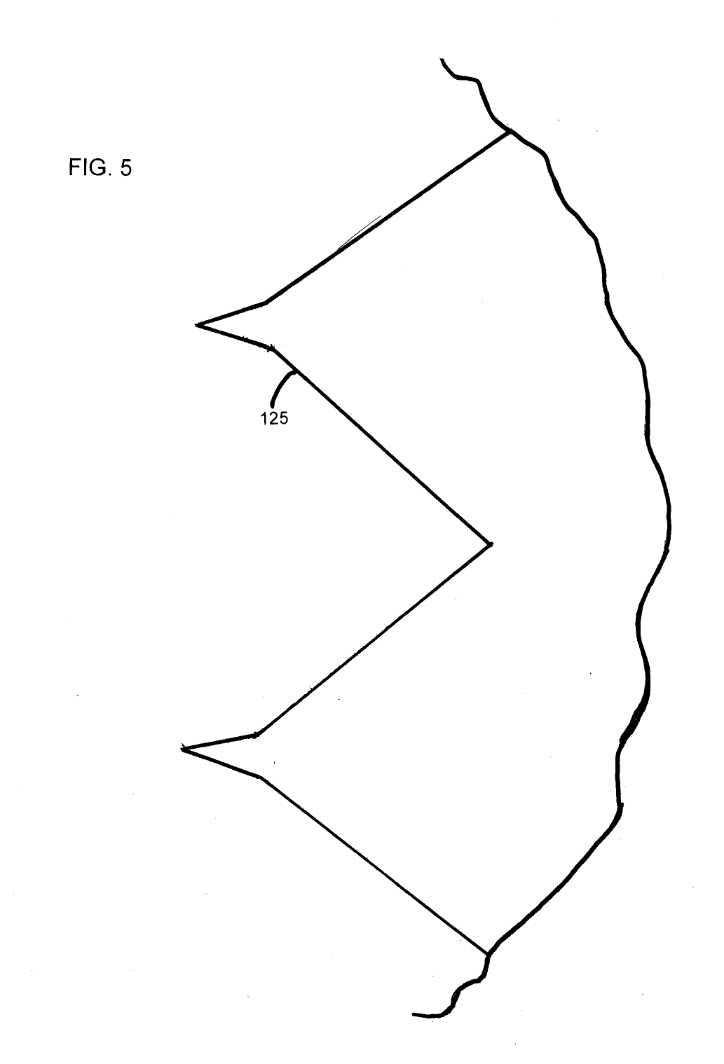

To assist with deeper penetration of the plate section 32 between overlapped shingles, the leading edge of the plate section 32 may have a progressively tapered teeth 125 as shown in FIG. 5. This arrangement generally allows the small leading end of the plate section 32 to extend past the nails, tacks, staples or other securing fasteners to be removed and thereby exert a greater prying or removal force thereon when the pivotable shingle removal blade 20 is actuated. It is to be appreciated that the leading end 38 of plate section 32 of the pivotable shingle removal blade 20 can have a variety of different shapes and/or configurations which facilitate removal of the desired nails, tacks, staples or other securing fasteners and shingles 36, e.g., permitting the leading edge of the plate to easily penetrate between shingles 36 secured to the roof 16 and assist with prying or otherwise lifting, removal of such nails, staples, tacks or other fasteners securing the shingles 36 to the roof 16.

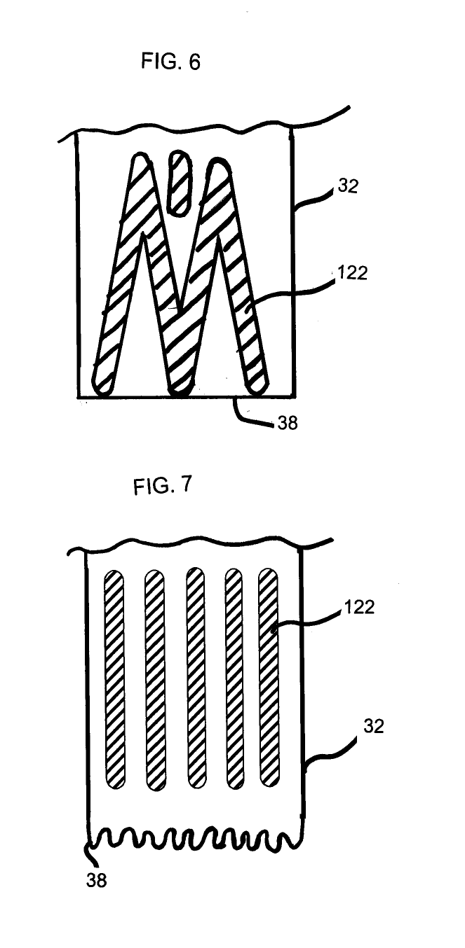

As shown in FIG. 6, the leading end 38 of the plate section 32 of the pivotable shingle removal blade 20 may have a substantially linear tapered edge while a plurality of smooth impressions, depressions, deformations, groves, indentations or other surface contours 122 are formed into the surface of a remainder of the plate section 32. Alternatively, as shown in FIG. 7, the leading end 38 of the plate section 32 of the pivotable shingle removal blade 20 may have a sinusoidal or some other undulating or non-linear profile. As with the previous embodiments, a plurality of smooth impressions, depressions, deformations, groves, indentations or other surface contours 122 are formed into the surface of the plate section 32 of the pivotable shingle removal blade 20.

It is to be appreciated that as the pivotable shingle removal blade 20 is pivoted to its pivoted second position 56, by the actuator 48, the leading edge 42 of the pivotable shingle removal blade 20 exerts a prying or removal force on any nails, shingles, staples, etc., engaged with the leading edge 42 thereof, while the base 10 of the shingle removal apparatus 2 is, in turn, generally forced downwardly against the roof 16 or other support surface so as to absorb the prying or removal force being generated by the pivotable shingle removal blade 20 on the nails, staples fasteners and/or shingles being removed. Preferably the bottom surface 126 of the base 10 is sufficiently ridged and has sufficient structural integrity so as to be able to readily absorb and transfer such force to the roof over prolonged periods of time, e.g., many months or many years, without any detrimental impact to the base 10 or other components of the shingle removal apparatus 2.

The pressurized air source 64 is preferably a pneumatic air compressor which is capable of generating between about 50 and about 250 psi of pressure and more preferably generating an operating pressure of about 100 psi. Depending on the size, the length and the stroke of each pneumatic cylinder 60, one or more pneumatic cylinders 60 may be required in order to exert the desired pivoted force on the shingle removal blade 20 relative to the remainder of the shingle removal apparatus 2.

The handle 4 typically has a hook, eye hook or some other attachment mechanism 128 which facilitates attaching a safety line, for example, to secure the shingle removal apparatus 2 to safety belt worn by an operator or possibly to the peak or some other area of the roof 16, for example, and prevent the shingle removal apparatus 2 from inadvertently falling, rolling and/or being pushed off the roof 16 and possibly causing injury to an individual or property damage.

It is to be appreciated that lifting or prying force, to be generated by the pivotable shingle removal blade 20 and the base 10 of the shingle removal apparatus 2, can be quite high. Accordingly, at least the pivotable shingle removal blade 20 and the shingle removal apparatus 2 are manufactured from a sufficiently ridged material such as steel, and possibly reinforced aluminum depending on the thickness and shape of the aluminum. If aluminum is utilized, the various components must have sufficient structural integrity to withstand prolonged use under extreme conditions.

Since certain changes may be made in the above described improved the shingle removal apparatus, without departing from the spirit and scope of the invention herein involved, it is intended that all of the subject matter of the above description or shown in the accompanying drawings shall be interpreted merely as examples illustrating the inventive concept herein and shall not be construed as limiting the invention.

Wherefore I claim:

1. A shingle removal apparatus comprising:
a handle having opposed first and second ends;
a handle grip located at the first end of the handle;
a base located at the second end of the handle;
a pivotable shingle removal blade being pivotally attached to the base; and
at least one actuating mechanism coupling the pivotable shingle removal blade to the base to facilitate pivoting the pivotable shingle removal blade from a normal horizontal first position into an inclined second position which assists with removing shingles from a roof.

2. The shingle removal apparatus of claim 1, wherein the at least one actuating mechanism is an actuator, and the actuator, when actuated in response to a command initiated by an operator of the shingle removal apparatus, pivots the pivotable shingle removal blade from the first position into the second position and, as the pivotable shingle removal blade is actuated into the second position, the pivotable shingle removal blade exerts a prying force, generally normal to the roof, on any shingles located on top of the pivotable shingle removal blade, and such prying force generally removes fasteners which secure the shingles to the roof and thereby separates the fastened shingles from the roof.

3. The shingle removal apparatus of claim 2, wherein the actuator comprises at least one cylinder coupled to a pressurized fluid source via a conduit and a valve,
the at least one cylinder has an internal piston which is connected with the pivotable shingle removal blade,
the valve defines two separate flow paths for the pressurized fluid to flow to the at least one cylinder, the first flow path supplies the pressurized fluid to a first end of the at least one cylinder which forces the piston toward an opposite second end of the cylinder and pivots the pivotable shingle removal blade from the first position into the second position, and
the second flow path supplies the pressurized fluid to the second end of the at least one cylinder which forces the piston toward an opposite first end of the cylinder and pivots the pivotable shingle removal blade from the second position back into the first position.

4. The shingle removal apparatus of claim 2, wherein the actuator comprises at least one cylinder coupled to a pressurized fluid source via a conduit and a valve,
the at least one cylinder has an internal piston which is in connected with the pivotable shingle removal blade,
the valve defines a flow path for the pressurized fluid to flow to the at least one cylinder, the flow path supplies the pressurized fluid to a first end of the at least one cylinder which forces the piston toward an opposite second end of the cylinder and pivots the pivotable shingle removal blade from the first position into the second position.

5. The shingle removal apparatus of claim 4, wherein an automatic return device is located between the base and a rear surface of the pivotable shingle removal blade and as the actuator pivots the pivotable shingle removal blade from the first position into the second position, the automatic return device is stored with energy for returning the pivotable shingle removal blade back to the first position from the second position once the flow of pressurized fluid from the valve is terminated.

6. The shingle removal apparatus of claim 1, wherein the base supports a rolling member which facilitates manipulation of the shingle removal apparatus.

7. The shingle removal apparatus of claim 1, wherein the shingle removal blade is pivotal connected to the base via at least one hinge.

8. The shingle removal apparatus of claim 7, wherein the at least one hinge is a horizontal hinge comprises a first hinge section fixedly supported by a leading portion of the base and a second hinge section fixedly supported by a trailing, rear surface of the pivotable shingle removal blade, and a rod couples the first and second hinge sections with one another and defines a hinge axis.

9. The shingle removal apparatus of claim 7, wherein the pivotable shingle removal blade comprising a relatively thin and flat but relatively strong and durable plate section, and a leading edge of the plate section is slightly tapered to assist with penetration of the leading edge of the pivotable shingle removal blade between overlapped shingles.

10. The shingle removal apparatus of claim 9, wherein a surface of the plate section is provided with at least one surface contour which provides the plate section with increased structural integrity so as to minimize flexing and bending of the plate section during use thereof.

11. The shingle removal apparatus of claim 9, wherein an inclined section is connected to a trailing end of the plate section, and the first inclined section is contour to assist with further separation of partially removed shingles from the roof.

12. The shingle removal apparatus of claim 11, wherein the inclined section forms an angle with the plate section which ranges from between about 100 to about 170 degrees.

13. The shingle removal apparatus of claim 11, wherein a trailing edge of the inclined section is has a curved section which further assists with rolling and folding over of removed shingles back toward the pivotable shingle removal blade.

14. The shingle removal apparatus of claim 11, wherein a transition section is located at a joint formed between the plate section and the inclined section, and the transition smooth outs an interface between those two sections so as avoid any corners or other sharp angle areas being formed where removed shingles may catch or abut against and thereby hinder operation of the shingle removal apparatus.

15. The shingle removal apparatus of claim 3, wherein the pressurized fluid is pressurized air supplied at a pressure of between about 50 and about 250 pounds per square inch, and an accumulation chamber is located between the pressurized source and the valve, and the accumulation chamber permits a quantity of pressurized air to be stored closer to the valve for more rapid cycling of the at least one actuator.

16. The shingle removal apparatus of claim 4, wherein the pressurized fluid is pressurized air supplied at a pressure of between about 50 and about 250 pounds per square inch, and an accumulation chamber is located between the pressurized source and the valve, and the accumulation chamber permits a quantity of pressurized air to be stored closer to the valve for more rapid cycling of the at least one actuator.

17. A shingle removal apparatus comprising:
a handle having opposed first and second ends;
a handle grip located at the first end of the handle;
a base located at the second end of the handle;
a pivotable shingle removal blade being pivotally attached to the base; and
at least one actuator coupling the pivotable shingle removal blade to the base to facilitate pivoting the pivotable shingle removal blade from a horizontal normal first position into an inclined second position which assists with removing shingles from a roof, and the actuator, when actuated in response to a command initiated by an operator of the apparatus, pivots the pivotable shingle removal blade from the first position into the second position and, as the pivotable shingle removal blade is actuated into the second position, the pivotable shingle removal blade exerts a prying force, generally normal to the roof, on any shingles located on top of the pivotable shingle removal blade, and such force generally removes fasteners, securing shingles to the roof, and thereby separates such shingles from the roof;
the at least one actuator comprises at least one pneumatic cylinder coupled to a pressurized air source via a conduit and a valve,
the at least one cylinder has an internal piston which is connected with the pivotable shingle removal blade, and
the valve defines a first flow path for the pressurized fluid to flow to the at least one cylinder, the first flow path supplies the pressurized fluid to a first end of the at least one cylinder which forces the piston toward an opposite second end of the cylinder and pivots the pivotable shingle removal blade from the first position into the second position.

18. The shingle removal apparatus of claim 17, wherein an automatic return device is located between the base and a rear surface of the pivotable shingle removal blade and as the actuator pivots the pivotable shingle removal blade from the first position into the second position, the automatic return device is stored with energy for returning the pivotable shingle removal blade back to the first position from the second position once the flow of pressurized fluid from the valve is terminated.

19. The shingle removal apparatus of claim 18, wherein the base supports a rolling member which facilitates manipulation of the shingle removal apparatus,
the shingle removal blade is pivotally connected to the base via at least one hinge;
the at least one hinge is a horizontal hinge comprising a first hinge section fixedly supported by a leading portion of the base and a second hinge section fixedly supported by a trailing, rear surface of the pivotable shingle removal blade, and a rod couples the first and second hinge sections with one another and defines a hinge axis, and
the pivotable shingle removal blade comprises a relatively thin and flat but relatively strong and durable plate section, and a leading edge of the plate section is slightly tapered to assist with penetration of the leading edge of the pivotable shingle removal blade between overlapped shingles.

20. A method of removing shingles with a shingle removal apparatus comprising a handle having opposed first and second ends, a handle grip located at the first end of the handle, a base located at the second end of the handle, a pivotable shingle removal blade being pivotally attached to the base; and at least one actuating mechanism coupling the pivotable shingle removal blade to the base to facilitate pivoting the pivotable shingle removal blade from a horizontal normal first position into an inclined second position which assists with removing shingles from a roof, the method comprising the steps of:
initiating a command from an operator of the shingle removal apparatus to the at least one actuating mechanism;
pivoting, via the at least one actuator mechanism, the pivotable shingle removal blade from the first position into the second position, in response to the command initiated by an operator; and
exerting a prying force, via the pivotable shingle removal blade, on shingles overlying the pivotable shingle removal blade as the pivotable shingle removal blade is pivoted from the first position into the second position to remove fasteners securing shingles to the roof, and thereby separate the shingles from the roof.
